(19) United States
(12) Patent Application Publication
(10) Pub. No.: US 2020/0354285 A1
(43) Pub. Date: Nov. 12, 2020

(54) WATER DISPERSIBLE SULPHUR FERTILIZER COMPOSITION AND A PROCESS FOR PREPARATION THEREOF

(71) Applicant: Reliance Industries Limited, Mumbai (IN)

(72) Inventors: Kalpeshkumar Bhikhubhai Sidhpuria, Surat (IN); Sachin Rawalekar, Pune (IN); Prakash Kumar, Vadodara (IN); Kalpana Gopalakrishnan, Vadodara (IN); Mayur Navinchandra Talati, Rajkot (IN); John Lintoan, Kottayam (IN); Hemant Vasant Katti, Mumbai (IN); Raksh Vir Jasra, Vadodara (IN)

(73) Assignee: Reliance Industries Limited, Mumbai (IN)

(21) Appl. No.: 16/762,280

(22) PCT Filed: Nov. 21, 2018
(86) PCT No.: PCT/IB2018/059153

§ 371 Date: May 7, 2020

(30) Foreign Application Priority Data
Nov. 22, 2017 (IN) 201721041889

(51) Int. Cl. C05G 1/00; C05G 5/12; C05G 5/40; C05D 9/00; C05F 11/08

(52) U.S. Cl. CPC C05G 1/00; C05G 5/12; C05F 11/08; C05D 9/00; C05G 5/40

(57) ABSTRACT

The present disclosure relates to a water dispersible sulphur fertilizer composition. In one aspect, the fertilizer composition is prepared by mixing molten elemental sulphur with inorganic solid material to obtain a homogenized mixture that is quenched on a cold surface or water to obtain uneven sized flakes, which are mixed with sulphur solubilizing microbes, swelling agent, dispersing agent, binding agent and water, and then pugged and kneaded to obtain dough. The dough is processed to obtain shaped articles, which are dried at a temperature ranging from 25 to 50° C. to obtain the fertilizer composition. In another aspect, the fertilizer composition comprises 70 to 98 wt % elemental sulphur, 0.1 to 30 wt % inorganic solid material, 0.1 to 10 wt % swelling agent, 0.5 to 30 wt % dispersing agent and 0.5 to 30 wt % binding agent of the total weight of the composition. The fertilizer composition has crushing strength in the range of 3.0 to 3.8 Kgf.

### FIELD

The present disclosure relates to a water dispersible sulphur fertilizer.

### Definitions

As used in the present disclosure, the following terms are generally intended to have the meaning as set forth below, except to the extent that the context in which they are used indicate otherwise.

Pugging: Pugging is a process of working and tempering clay to make it of uniform consistency.

Kneading: Kneading is a process used to mix the ingredients and add strength to the final product. The ingredients are worked into a uniform mixture by pressing, folding, and stretching.

### BACKGROUND

The background information herein below relates to the present disclosure but is not necessarily prior art.

Sulphur is an important nutrient for plant growth. Most of the sulphur absorbed by plants is used for producing proteins and also for chlorophyll formation. Sulphur is an essential element of soil and is required for the growth of plants, either in its elemental form or in inorganic forms such as sulphates (SO₄²⁻) or as sulphur dioxide (SO₂) picked up from the atmosphere. In the elemental form, sulphur must be in a finely divided form for quick microbial action to convert it into water soluble sulphate, which can be readily absorbed by plants. Micronized sulphur in its elemental form is slowly oxidized to sulphate by soil bacteria namely Thiobacilus.

In the conventional fertilizers, the oxidation rate of sulphur depends upon the extent of formation of fine particles, which is enhanced by addition of bentonite clay. During production stage bentonite is mixed with sulphur through a hot process utilizing molten sulphur to form pellets. However, pellets formed by hot process utilizing molten sulphur, do not quickly disperse into fine particles thereby resulting into slower oxidation of sulphur because molten hydrophobic sulphur coats the clay particles during pellet formation which prevents clay to pick-up water and thus delays swelling.

Conventionally, granular fertilizer products can be prepared by allowing the droplets of molten sulphur to fall into a liquid fertilizer solution to anneal the droplets into pellets. However, such granular products produced in accordance with these conventional methods comprise non-spherical particles of irregular shape and rough surface. The rough surface of the irregular shaped products leads to the formation of an undesirable content of fine particles or dust, due to rubbing together of irregular shaped particles during processing and during the use of these granules. Sulphur dust is unpleasant and hazardous for health, and under certain circumstances may lead to an explosion. In some other processes, nitrogen coated dust free sulphur pellets are produced, but the process of manufacturing such pellets requires the use of large volumes of expensive nitrogen containing liquid fertilizer to anneal the molten droplets and form the coating.

Therefore, there is felt a need for a stable and dust free sulphur fertilizer composition, which is bio-degradable, has a high water holding capacity, and has a quick dispersion rate.

Objects

Some of the objects of the present disclosure, which at least one embodiment herein satisfies, are as follows:

It is an object of the present disclosure to ameliorate one or more problems of the prior art or to at least provide a useful alternative.

It is an object of the present disclosure to provide a process for the preparation of a sulphur fertilizer composition.

It is another object of the present disclosure to provide a water dispersible sulphur based fertilizer composition.

It is yet another object of the present disclosure to provide a water dispersible sulphur based composition which is dust free, water dispersible and bio-degradable.

Other objects and advantages of the present disclosure will be more apparent from the following description, which is not intended to limit the scope of the present disclosure.

### SUMMARY

In one aspect, the present disclosure provides a process for preparing a fertilizer composition, which involves melting elemental sulphur at a temperature in the range of 120 to 160° C. and admixing the molten elemental sulphur with at least one inorganic solid material to obtain a homogenized mixture. The homogenized mixture is quenched on a cold surface or in water to obtain a quenched mixture comprising uneven sized flakes or pastilles, to which sulphur solubilizing microbe, at least one binding agent and water are added to obtain an aqueous solid mixture that is pugged and kneaded to obtain dough. The dough is processed using at least one technique selected from the group consisting of pelletizing, pastilling, extruding and granulating to obtain shaped articles, which are dried at a temperature in the range of 25 to 50° C. to obtain the fertilizer composition. The process comprises adding at least one swelling agent and at least one dispersing agent either in the step of admixing the molten elemental sulphur with at least one inorganic solid material to obtain a homogenized mixture or in the step of adding binding agent to the quenched mixture comprising uneven sized flakes or pastilles to obtain an aqueous solid mixture.

Typically, in accordance with the process of the present disclosure, the step of pugging and kneading further comprises adding plant growth regulator to the uneven sized flakes.

In another aspect, the present disclosure provides a water dispersible sulphur fertilizer composition comprising 70 to 98 wt % elemental sulphur, 0.1 to 30 wt % inorganic solid material selected from the group consisting of mineral clays and gypsum, 0.1 to 10 wt % swelling agent, 0.5 to 30 wt % dispersing agent and 0.5 to 30 wt % binding agent based on the total weight of the composition, and sulphur solubilizing microbe in an amount ranging from 10⁵ to 10¹⁰ cells per ml of the fertilizer composition. The fertilizer composition is characterized by having a crushing strength in the range of 2.8 to 4.5 Kgf and moisture content ranging from 0.1 to 1.0 wt % of the total weight of the fertilizer composition.

In accordance with the present disclosure, the fertilizer composition further comprises at least one plant growth regulator in an amount ranging from 0.005 to 5 wt % of the total weight of the composition.

In accordance with the present disclosure, the sulphur solubilizing microbe is at least one selected from the group consisting of Thiobacillus thiooxidans, Thiobacillus ferroxidans, Thiobacillus thioparus, Thiobacillus prosperus, Thiobacillus intermedius, Beggiatoa, and Thiobacillus denitrificans.

In accordance with the present disclosure, the sulphur solubilizing microbe is Thiobacillus thiooxidans.

In accordance with the present disclosure, the inorganic solid material is selected from the group consisting of mineral clays and gypsum, wherein the mineral clay is at least one selected from the group consisting of kaolin, attapulgite and bentonite.

In accordance with the present disclosure, the swelling agent is at least one selected from the group consisting of polyacrylic acid, polyacrylate, polyacrylamide, Superabsorbent polymers (SAPs), cellulose grafted polyacrylamide, potassium salt of polyacrylamide and starch grafted polyacrylamide.

In accordance with the present disclosure, the dispersing agent is at least one selected from the group consisting of sodium salt of naphthalene sulphonate condensate, sodium alkyl naphthalene sulphonate blend, polyurethane, polyacrylate based dispersing agent, and calcium lignosulphonate.

In accordance with the present disclosure, the binding agent is at least one selected from the group consisting of carboxymethyl cellulose, methyl cellulose, ethyl cellulose, hydroxymethyl cellulose, hydroxyethyl cellulose, hydroxypropylmethyl cellulose, hydroxyethylpropyl cellulose, corn starch, potato starch, starch acetates, ionic starches, polyvinyl alcohol, polyvinyl acetate, polyethylene glycol and polylactic acid.

### BRIEF DESCRIPTION OF THE ACCOMPANYING DRAWING

The present disclosure will now be described with the help of the accompanying drawing, in which:

FIG. 1 illustrates a schematic of process flow diagram for preparing a water dispersible sulphur fertilizer composition in accordance with the present disclosure.

| Reference | |
|---|---|
| number | Elements |
| 101 | Molten Sulphur Source |
| 102 | Inorganic Material Source |
| 103 | Homogenized Mixture |
| 104 | Quenched Mixture |
| 105 | Sulphur stabilizing Microbes source |
| 106 | Swelling Agent Source |
| 107 | Dispersing Agent Source |
| 108 | Binding Agent Source |
| 109 | Water Source |
| 110 | Aqueous Solid Mixture |
| 111 | Pugged and Kneaded Dough |
| 112 | Extrudates |

FIG. 2 illustrates a schematic of process flow diagram for preparing a water dispersible sulphur fertilizer composition in accordance with the present disclosure.

| Reference | |
|---|---|
| number | Elements |
| 201 | Molten Sulphur Source |
| 202 | Inorganic Material Source |
| 203 | Homogenized Mixture |
| 204 | Quenched Mixture |
| 205 | Sulphur stabilizing Microbes source |
| 206 | Swelling Agent Source |
| 207 | Dispersing Agent Source |
| 208 | Binding Agent Source |
| 209 | Water Source |
| 210 | Aqueous Solid Mixture |
| 211 | Pugged and Kneaded Dough |
| 212 | Extrudates |

### DETAILED DESCRIPTION

Embodiments are provided so as to thoroughly and fully convey the scope of the present disclosure to the person skilled in the art. Numerous details, are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, integers, steps, operations, elements, modules, units and/or components, but do not forbid the presence or addition of one or more other features, integers, steps, operations, elements, components, and/or groups thereof. The particular order of steps disclosed in the method and process of the present disclosure is not to be construed as necessarily requiring their performance as described or illustrated. It is also to be understood that additional or alternative steps may be employed.

Sulphur (S) is an essential plant nutrient required by all crops for optimum growth and yield. Sulphur is essential in the structural and enzymatic components in plants and is a key component of some essential amino acids and is needed for protein synthesis. Chlorophyll synthesis also requires sulphur. Moreover, sulphur is not readily translocated within plants, so all plants need a continuous supply of sulphur from emergence to crop maturity. Hence, sulphur deficiency at any growth stage can result in reduced crop growth and yield.

The gaseous hydrogen sulphide is found in raw natural gas or from the by-product gases containing hydrogen sulphide derived from refining crude oil and other industrial processes. The Claus process is used for recovering the elemental sulphur from the gaseous hydrogen sulphide.

In accordance with one aspect of the present disclosure, a process for preparing a water dispersible sulphur fertilizer composition is envisaged.

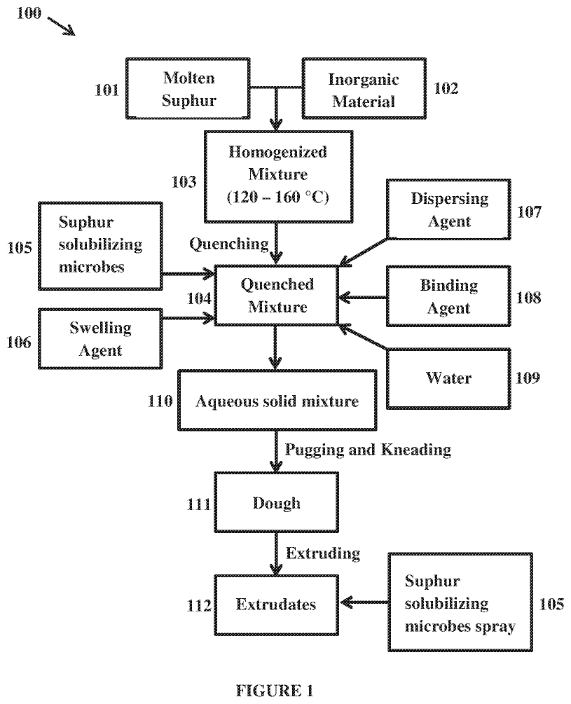

The process for water dispersible sulphur fertilizer composition of the present disclosure is described with reference to FIG. 1, which depicts a schematic flow diagram (100) of the process.

In accordance with the embodiments of the present disclosure, the fertilizer composition is prepared by initially heating a predetermined amount of elemental sulphur at a temperature in the range of 120 to 160° C., to obtain molten elemental sulphur (101).

This molten sulphur is kept at a temperature in the range of 120 to 160° C. to keep the molten sulphur in a flowable form. This enables better mixing of the molten sulphur with other ingredients.

In one embodiment, predetermined amounts of at least one inorganic solid material (102) is added to the molten elemental sulphur and mixed thoroughly at a predetermined speed and time to obtain a homogenized mixture (103). This homogenized mixture is then quenched on a cold surface or in water to obtain a quenched mixture (104) comprising un-even sized flakes or pastilles. Predetermined amounts of sulphur stabilizing microbes (105), at least one swelling agent (106), at least one dispersing agent (107), at least one binding agent (108), and water (109) are added to the un-even sized flakes or pastilles to obtain an aqueous solid mixture (110), followed by pugging and kneading the aqueous solid mixture to obtain a dough (111) (addition of binding agent along with swelling agent and dispersing agent during pugging and kneading stages, Examples 8-11). This dough is then processed to form shaped articles (112).

The addition of binding agent along with swelling agent and dispersing agent during pugging and kneading stages, as described in Examples 8-11, results in the formation extrudates of the fertilizer composition having crushing strength in the range of 3.6 to 3.8 Kgf, thereby providing extrudates with smooth texture and low shear on surface. The fertilizer composition obtained according to the process of Examples 8-11, has higher water holding capacity and quick dispersion properties.

In accordance with the embodiments of the present disclosure, the dough is processed by at least one of the steps selected from the group consisting of, but not limited to, pelletizing, pastilling, extruding and granulating. The so formed shaped articles were air dried at 25 to 50° C. to obtain the sulphur fertilizer composition. As per the present disclosure, the fertilizer composition is in the form of shaped articles like pellets, pastilles, extrudates, beads, flakes, prills and granules.

In an exemplary embodiment of the present disclosure, the fertilizer composition comprises 91 wt % molten elemental sulphur of the total weight of the composition, 6 wt % inorganic solid material of the total weight of the composition, 1 wt % swelling agent of the total weight of the composition, 1 wt % dispersing agent of the total weight of the composition and 1 wt % binding agent of the total weight of the composition, and 10⁸ cells per ml sulphur solubilizing microbe.

In accordance with the embodiments of the present disclosure, the fertilizer composition further comprises at least one plant growth regulator can be added in predetermined amounts to the un-even sized flakes or pastilles followed by pugging and kneading to obtain a dough.

In accordance with the embodiments of the present disclosure, the extrudates can be 1 to 4 mm in size. The moisture content of the dried extrudates can be less than 0.5 wt % on dry weight basis.

In another embodiment of the present disclosure, the fertilizer composition is prepared by initially heating a predetermined amount of elemental sulphur at a temperature in the range of 120 to 160° C., to obtain molten elemental sulphur. The Claus process can be used for recovering the elemental sulphur from the gaseous hydrogen sulphide. The gaseous hydrogen sulphide can be found in raw natural gas or from the by-product gases containing hydrogen sulphide derived from refining crude oil and other industrial processes.

This molten sulphur is kept at a temperature in the range of 120 to 160° C. to keep the molten sulphur in a flow-able form. This enables better mixing of the molten sulphur (101) with other ingredients.

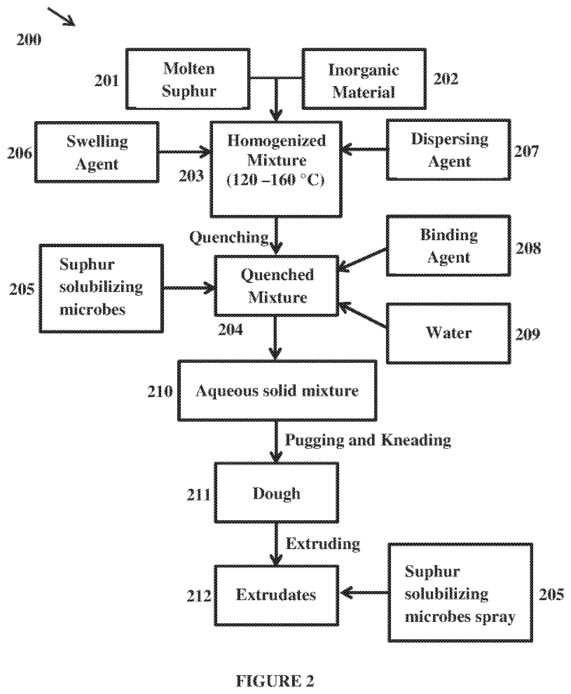

In another embodiment, the process for preparing fertilizer composition of the present disclosure is described with reference to FIG. 2, which depicts a schematic flow diagram (200) of the process, involes combining predetermined amounts of at least one inorganic solid material (202), at least one swelling agent (206), and at least one dispersing agent (207), which are then added to the molten elemental sulphur (201) and mixed thoroughly at a predetermined speed and time to obtain a homogenized mixture This homogenized mixture is then quenched on a cold surface or in water to get un-even sized flakes or pastilles. Further, in predetermined amounts, at least one binding agent (208), and water (209) are added to the un-even sized flakes or pastilles followed by pugging and kneading to obtain a dough (addition of binding agent during pugging and kneading stages, Examples 1-7, and 12-16). This dough is then extruded in an extruder to obtain extrudates. The so formed extrudates were air dried at 25 to 50° C. to obtain the sulphur fertilizer composition of the present disclosure in the form of shaped articles like pellets, pastilles, extrudates, beads, flakes, prills and granules.

Addition of the binding agent during pugging and kneading stages, in Examples 1-7 and 12-16, results in the formation of fertilizer composition having moderately higher crushing strength in the range of 3.0-3.3 Kgf in comparision to the crushing strength of 2.8 Kgf of the fertilizer composition prepared according to the process of the comparative Example 1.

Thus, the process of the present disclosure provides extrudates of fertilizer composition with moderately smooth texture and moderate shears on surface.

Whereas, the fertilizer composition prepared according to the process of the comparative Example 1, leads to difficulties in extruding the fertilizer composition into shaped extrudates. Further, the extrudates have very rough surfaces and higher amounts of shears on surface, which results in dust formation. In another aspect of the present disclosure, a water dispersible sulphur fertilizer composition is envisaged, which can rapidly disintegrate and disperse into fine particles upon contact with water or moisture present in the soil and improve the oxidation of sulphur into sulphate.

In an exemplary embodiment of the present disclosure, there is provided a fertilizer composition comprising elemental sulphur in an amount ranging from 70 to 98 wt % of the total weight of the composition, at least one inorganic solid material in an amount ranging from 0.1 to 30 wt % of the total weight of the composition, at least one swelling agent in an amount ranging from 0.1 to 10 wt % of the total weight of the composition, at least one dispersing agent in an amount ranging from 0.5 to 30 wt % of the total weight of the composition and at least one binding agent in an amount ranging from 0.5 to 30 wt % of the total weight of the composition, and sulphur solubilizing microbes having a concentration in the range of 10⁵ cells/ml to 10¹⁰ cells/ml. The fertilizer composition is characterized by having a crushing strength in the range of 2.8 to 4.5 Kgf and moisture content ranging from 0.1 to 1.0% w/w of the total weight of the fertilizer composition.

The fertilizer composition can be in the form of shaped articles like pellets, pastilles, extrudates, beads, flakes, prills and granules. Typically, the size of the shaped articles of the fertilizer composition can be in the range of 1 to 6 mm.

In accordance with the preferred embodiments of the present disclosure, the fertilizer composition has crushing strength in the range of 3.6 to 3.8 Kgf.

It is observed that the extrudates of the fertilizer composition having crushing strength in the range of 3.6 to 3.8 Kgf are characterized by smooth texture and low shear on surface.

In accordance with one embodiment of the present disclosure, the the fertilizer composition has 0.5 wt % moisture content of the total weight of the fertilizer composition.

It is observed that the fertilizer composition is characterized by swelling in the range of 2 to 280 percent of its original volume.

It is observed that the fertilizer composition disperses in water in a time period in the range of 0.1 to 24 hours.

In accordance with the embodiments of the present disclosure, the extrudates of fertilizer composition have size in the range of 1.5 to 6 mm.

In accordance with one embodiment of the present disclosure, the extrudates of fertilizer composition have size of 3 mm.

In accordance with the embodiments of the present disclosure, the fertilizer composition further comprises at least one plant growth regulator in an amount ranging from 0.005 to 5% of the total weight of the composition.

The oxidation of sulphur into sulphate form is enhanced in the presence of the sulphur solubilizing microbes.

In accordance with the embodiments of the present disclosure, the sulphur solubilizing microbes is at least one selected from the group consisting of Thiobacillus thiooxidans, Thiobacillus ferroxidans, Thiobacillus thioparus, Thiobacillus prosperus, Thiobacillus intermedius, Beggiatoa, and Thiobacillus denitrificans.

In an exemplary embodiment, the sulphur solubilizing microbes is Thiobacillus thiooxidans.

The sulphur solubilizing microbe i.e. Thiobacillus thiooxidans (ATCC-8085), used in present disclosure is purchased from American Type Culture Collection, USA, through their Indian agent M/s, LGC Promochem India Pvt. Ltd., Bangalore.

In accordance with the preferred embodiments of the present disclosure, the inorganic solid material is in the range of 6 to 8 wt % of the total weight of the fertilizer composition.

In accordance with one embodiment of the present disclosure, the inorganic solid material is 7 wt % of the total weight of the fertilizer composition.

In accordance with the embodiments of the present disclosure, the inorganic solid material is at least one selected from the group consisting of mineral clays and gypsum. Typically, the mineral clay is at least one selected from the group consisting of kaolin, attapulgite, and bentonite.

In accordance with one embodiment of the present disclosure, the mineral clay is bentonite.

In accordance with another embodiment of the present disclosure, the mineral clay is attapulgite.

In accordance with yet another embodiment of the present disclosure, the mineral clay is kaolin.

In accordance with one embodiment of the present disclosure, gypsum is also used as inorganic material.

The oxidation rate of sulphur depends upon extent of fine particles formation, which is enhanced by addition of inorganic solid material, swelling agent and dispersing agent otherwise sulphur oxidation takes place at slow rate.

In accordance with the preferred embodiments of the present disclosure, the swelling agent is in the range of 0.5 to 1 wt % of the total weight of the fertilizer composition.

In accordance with one embodiment of the present disclosure, the swelling agent is 1 wt % of the total weight of the fertilizer composition.

The swelling agent can absorb water upto 300 to 400 times greater than its weight and expand, leading to breaking of the sulphur fertilizer composition into fine particles suitable for oxidation.

In accordance with the embodiments of the present disclosure, the swelling agent is at least one selected from the group consisting of polyacrylic acid, polyacrylate, polyacrylamide, Superabsorbent polymers (SAPs), cellulose grafted polyacrylamide or polyacrylate, potassium salt of polyacrylamide or polyacrylate and starch grafted polyacrylamide or polyacrylate.

The dispersing agent rapidly disperses the sulphur fertilizer composition into fine particles and the sulphur solubilizing microbes accelerates the oxidation of dispersed elemental sulphur particles into plant available sulphate form.

In accordance with the embodiments of the present disclosure, the dispersing agent is at least one selected from the group consisting of sodium salt of naphthalene sulphonate condensate, sodium alkyl naphthalene sulphonate blend, polyurethane, polyacrylate based dispersing agent, and calcium lignosulphonate.

In accordance with the embodiments of the present disclosure, the binding agent is at least one selected from the group consisting of carboxymethyl cellulose, methyl cellulose, ethyl cellulose, hydroxymethyl cellulose, hydroxyethyl cellulose, hydroxypropylmethyl cellulose, hydroxyethylpropyl cellulose, corn starch, potato starch, starch acetates, ionic starches, polyvinyl alcohol, polyvinyl acetate, polyethylene glycol and polylactic acid.

In accordance with one embodiment of the present disclosure, the binding agent is carboxymethyl cellulose.

In accordance with the embodiments of the present disclosure, the plant growth regulator can be at least one selected from the group consisting of auxins, gibberellins, cytokines and abscisic acid (ABA). Typically, the plant growth regulator can be at least one selected from the group consisting of indole-3-acetic acid (IAA), gibberellic acid (GA) and 6-benzyl adenine (BA).

The foregoing description of the embodiments has been provided for purposes of illustration and not intended to limit the scope of the present disclosure. Individual components of a particular embodiment are generally not limited to that particular embodiment, but, are interchangeable. Such variations are not to be regarded as a departure from the present disclosure, and all such modifications are considered to be within the scope of the present disclosure.

The present disclosure is further described in light of the following experiments which are set forth for illustration purpose only and not to be construed for limiting the scope of the disclosure. The following experiments can be scaled up to industrial/commercial scale and the results obtained can be extrapolated to industrial scale.

### EXPERIMENTAL DETAILS

### Experiment-1: Preparation of Water Dispersible Sulphur Fertilizer Composition

### Comparative Examples 1: Preparation of Fertilizer Composition by Adding Binding Agent to the Molten Sulphur, Before the Step of Quenching

In a typical experiment, required amount of clay was added in 910 g of molten sulphur and mixed for sufficient time to get homogeneous slurry. In this slurry, required amount of dispersing agent, swelling agent and binding agent (carboxymethyl cellulose) was added as shown in below Table 1. The slurry was quenched on cold surface or in water to get un-even sized flakes or pastilles. Required amount of water was added to the prepared flakes or pastilles mixture. The mixture was subjected to pugging followed by kneading to obtain dough. The formed dough was then extruded to obtain extrudates, having 3 mm size, using an extruder. The so formed extrudates were air dried at 35-50° C. The moisture content of the dried extrudates was found to be less than 0.5 wt % on dry weight basis.

The crushing strength of the fertilizer composition are presented in Table-2.

### Examples 1-7 and 12-16: Preparation of Fertilizer Composition by Adding Binding Agent to all the Other Ingradients after the Step of Quenching

In a typical experiment, required amount of clay was added in 910 g of molten sulphur and mixed for sufficient time to get homogeneous slurry. In this slurry, required amount of dispersing agent and swelling agent was added as shown in below Table 1. The slurry was quenched on cold surface or in water to get un-even sized flakes or pastilles. A binding agent (carboxymethyl cellulose) and water was added to the prepared flakes or pastilles mixture. The mixture was subjected to pugging followed by kneading to obtain dough. The formed dough was then extruded to obtain extrudates, having 3 mm size, using an extruder. The so formed extrudates were air dried at 35-50° C. The moisture content of the dried extrudates was found to be less than 0.5 wt % on dry weight basis.

The crushing strength of the fertilizer composition are presented in Table-2.

### Experiment-2: Preparation of Fertilizer Composition by Adding Binding Agent Along with Dispersing Agent and Swelling Agent, after the Step of Quenching

### Examples 8-11

In a typical experiment, required amount of clay was added in 910 g of molten sulphur and mixed for sufficient time to get homogeneous slurry. The slurry was quenched on cold surface or in water to get un-even sized flakes or pastilles. Required amount of dispersing agent, swelling agent, binding agent (carboxymethyl cellulose) and water was added to the prepared flakes or pastilles mixture as shown in Table 1 (examples 8 to 11). Pugging of the so formed mixture was done followed by kneading to obtain a dough. Thus formed dough was then extruded to obtain extrudates, having 3 mm size, using an extruder. The so formed extrudates were air dried at 35-50° C. The moisture content of the dried extrudates was found to be less than 0.5 wt % on dry weight basis.

The crushing strength of the fertilizer composition are presented in Table-2.

TABLE 1
provides the type of components in the fertilizer composition
and their corresponding quantities

| | | | | | | Swelling | |
|---|---|---|---|---|---|---|---|
| | | | | | | agent (g) | Binding |
| | | | | | | (potassium | agent (g) |
| | | Clay | | Dispersing agent (g) | | salt of | (Carboxy- |
| | Sulphur | | Quantity | | Quantity | polyacryla- | methyl |
| Example | (g) | Type | (g) | Type | (g) | mide) | cellulose) |
| Comparative | 910 | bentonite | 60 | Sodium | 10 | 10 | 10 |
| Example 1 | | | | salt of | | | |
| | | | | naphthalene | | | |
| | | | | sulfonate | | | |
| | | | | condensate | | | |
| | | | | (Morwet D | | | |
| | | | | 425) | | | |
| 1 | 910 | Bentonite | 80 | — | 0 | 0 | 10 |
| 2 | 910 | Bentonite | 70 | — | 0 | 10 | 10 |
| 3 | 910 | Bentonite | 70 | Sodium | 10 | 0 | 10 |
| | | | | salt of | | | |
| | | | | naphthalene | | | |
| | | | | sulfonate | | | |
| | | | | condensate | | | |
| | | | | (Morwet D | | | |
| | | | | 425) | | | |
| 4 | 910 | Bentonite | 60 | Sodium | 10 | 10 | 10 |
| | | | | salt of | | | |
| | | | | naphthalene | | | |
| | | | | sulfonate | | | |
| | | | | condensate | | | |
| | | | | (Morwet D | | | |
| | | | | 425) | | | |
| 5 | 910 | Bentonite | 65 | Sodium | 5 | 10 | 10 |
| | | | | salt of | | | |
| | | | | naphthalene | | | |
| | | | | sulfonate | | | |
| | | | | condensate | | | |
| | | | | (Morwet D | | | |
| | | | | 425) | | | |
| 6 | 910 | Bentonite | 70 | Sodium | 5 | 5 | 10 |
| | | | | salt of | | | |
| | | | | naphthalene | | | |
| | | | | sulfonate | | | |
| | | | | condensate | | | |
| | | | | (Morwet D | | | |
| | | | | 425) | | | |
| 7 | 910 | Bentonite | 65 | Sodium | 10 | 10 | 5 |
| | | | | salt of | | | |
| | | | | naphthalene | | | |
| | | | | sulfonate | | | |
| | | | | condensate | | | |
| | | | | (Morwet D | | | |
| | | | | 425) | | | |
| 8 | 910 | Bentonite | 70 | — | 0 | 10 | 10 |
| 9 | 910 | Bentonite | 60 | Sodium | 10 | 10 | 10 |
| | | | | salt of | | | |
| | | | | naphthalene | | | |
| | | | | sulfonate | | | |
| | | | | condensate | | | |
| | | | | (Morwet D | | | |
| | | | | 425) | | | |
| 10 | 910 | Bentonite | 65 | Sodium | 10 | 10 | 5 |
| | | | | salt of | | | |
| | | | | naphthalene | | | |
| | | | | sulfonate | | | |
| | | | | condensate | | | |
| | | | | (Morwet D | | | |
| | | | | 425) | | | |
| 11 | 910 | Bentonite | 75 | Sodium | 5 | 5 | 5 |
| | | | | salt of | | | |
| | | | | naphthalene | | | |
| | | | | sulfonate | | | |
| | | | | condensate | | | |
| | | | | (Morwet D | | | |
| | | | | 425) | | | |
| 12 | 910 | Bentonite | 70 | Sulphonic | 5 | 5 | 10 |
| | | | | acid | | | |
| | | | | condensation | | | |
| | | | | product | | | |
| | | | | (Tamol FB | | | |
| | | | | PP) | | | |
| 13 | 910 | Bentonite | 70 | Sodium | 5 | 5 | 10 |
| | | | | alkyl | | | |
| | | | | naphthalene | | | |
| | | | | sulfonate | | | |
| | | | | blend | | | |
| | | | | (Morwet | | | |
| | | | | EFW) | | | |
| 14 | 910 | Bentonite | 70 | Alkylpoly- | 5 | 5 | 10 |
| | | | | glycoside | | | |
| | | | | (Aqnique | | | |
| | | | | PG 8107) | | | |
| 15 | 910 | Kaoline | 70 | Sodium | 5 | 5 | 10 |
| | | | | salt of | | | |
| | | | | naphthalene | | | |
| | | | | sulfonate | | | |
| | | | | condensate | | | |
| | | | | (Morwet D | | | |
| | | | | 425) | | | |
| 16 | 910 | Gypsum | 70 | Sodium | 5 | 5 | 10 |
| | | | | salt of | | | |
| | | | | naphthalene | | | |
| | | | | sulfonate | | | |
| | | | | condensate | | | |
| | | | | (Morwet D | | | |
| | | | | 425) | | | |

TABLE 2
provides comparision of the crushing strengths of the fertilizer compositions
prepared by in-situ and ex-situ methods as against the comparative example 1

| | | Crushing | |
|---|---|---|---|
| | Preparation | Strength, | |
| Example | method | Kgf | Remarks |
| | Extrusion method | 3.8-4.5 | Smooth texture |
| | | | product with less |
| | | | shears on surface |
| Comparative | Hot process involving molten | 2.8 | Very rough surface |
| Example 1 | sulphur, in which all ingredients | | with high shears on |
| | such as clay, binding agent, | | surface, extrusion is |
| | swelling agent, dispersing agent are | | difficult. |
| | mixed in molten sulphur, followed | | |
| | by quenching the mixture in cold | | |
| | water and then pugging, | | |
| | kneading, extruding. | | |
| Examples 1-7 | Hot process involving molten | 3.0-3.3 | Moderately smooth |
| and 12-16 | sulphur, in which clay, swelling | | surface with |
| | agent and dispersing agent are | | moderate amounts of |
| | mixed in molten sulphur, followed | | shears on surface. |
| | by quenching the mixture in cold | | |
| | water and then binding agent is | | |
| | added at the time of pugging and | | |
| | kneading stage, and then extruding. | | |
| Examples | Hot process involving molten | 3.6-3.8 | Smooth texture |
| 8 to 11 | sulphur, in which a mixture of | | product with less |
| | molten sulphur and clay is | | shears on surface. |
| | quenched in cold water, followed | | |
| | by addition of bindining agent, | | |
| | swelling agent and dispersing | | |
| | agent at the time of pugging, | | |
| | kneading stage, further followed | | |
| | by extrusion | | |

From Table-2, it is clearly observed that the crushing strength of the fertilizer composition prepared according to the process of Examples 8-11, is in the range of 3.6 to 3.8 Kgf, is higher as compared to the crushing strength of 2.8 Kgf, of the fertilizer composition prepared according to the process of Comparative Example 1.

Similarly, it is clear from Table-2 that the crushing strength of the fertilizer composition prepared according to the process of Examples 1-7, and 12-16, is in the range of 3.0 to 3.3 Kgf, is higher as compared to the crushing strength of 2.8 Kgf, of the fertilizer composition prepared according to the process of Comparative Example 1.

Thus, extrudates of the fertilizer composition prepared using the process of the present disclosure, have low shear and smooth surface. Whereas, there are processing issues observed during the extrusion of fertilizer composition prepared according to the process of Comparative Example 1, and the extrudates have high shear and rough surface.

The fertilizer composition obtained according to the process of the present disclosure (Examples 1-16) has higher water holding capacity and quick dispersion properties as compared to the fertilizer composition obtained according to the process of the Comparative Example 1.

### TECHNICAL ADVANCES AND ECONOMICAL SIGNIFICANCE

The present disclosure described herein above has several technical advantages including, but not limited to, the realization of:
a water dispersible sulphur fertilizer composition which is bio-degradable, has high water holding capacity, and a quick dispersion rate;
a water dispersible sulphur fertilizer composition which is stable and dust free; and
an easy and economical process for the preparation of the water dispersible sulphur fertilizer composition.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1. A process for preparing a water dispersible sulphur based fertilizer composition; said process comprising the following steps:
i. melting elemental sulphur at a temperature in the range of 120 to 160° C. and admixing said molten elemental sulphur with at least one inorganic solid material to obtain a homogenized mixture;
ii. quenching said homogenized mixture on a cold surface or in water to obtain a quenched mixture comprising uneven sized flakes or pastiles;
iii. adding sulphur solubilizing microbe, at least one binding agent and water to the uneven sized flakes to obtain an aqueous solid mixture, followed by pugging and kneading the aqueous solid mixture to obtain a dough;
iv. processing said dough to obtain shaped articles, wherein said step of processing is at least one selected from the group consisting of pelletizing, pastilling, extruding and granulating; and
v. drying said shaped articles at a temperature ranging from 25 to 50° C. to obtain said fertilizer composition,
wherein said process comprises adding at least one swelling agent and at least one dispersing agent in either step (i) or step (iii).

2. The process as claimed in claim 1, wherein step (iii) further comprises adding plant growth regulator to the uneven sized flakes.

3. A water dispersible sulphur based fertilizer composition, said fertilizer composition comprising:
a) elemental sulphur in an amount ranging from 70 to 98 wt % of the total weight of the fertilizer composition;
b) an inorganic solid material in an amount ranging from 0.1 to 30 wt % of the total weight of the composition;
c) a swelling agent in an amount ranging from 0.1 to 10 wt % of the total weight of the fertilizer composition;
d) a dispersing agent in an amount ranging from 0.5 to 30 wt % of the total weight of the fertilizer composition;
e) a binding agent in an amount ranging from 0.5 to 30 wt % of the total weight of the fertilizer composition; and
f) sulphur solubilizing microbe in an amount ranging from 10⁵ to 10¹⁰ cells per ml of the fertilizer composition,
wherein said fertilizer composition is characterized by having a crushing strength in the range of 0.5 to 6.0 Kgf and moisture content ranging from 0.1 to 1.0 wt % of the total weight of the fertilizer composition.

4. The fertilizer composition as claimed in claim 3, wherein said fertilizer composition further comprises at least one plant growth regulator in an amount ranging from 0.005 to 5 wt % of the total weight of the composition.

5. The fertilizer composition as claimed in claim 3, wherein said sulphur solubilizing microbe is at least one selected from the group consisting of Thiobacillus thiooxidans, Thiobacillus ferroxidans, Thiobacillus thioparus, Thiobacillus prosperus, Thiobacillus intermedius, Beggiatoa, and Thiobacillus denitrificans.

6. The fertilizer composition as claimed in claim 3, wherein said sulphur solubilizing microbe is Thiobacillus thiooxidans.

7. The fertilizer composition as claimed in claim 3, wherein said inorganic solid material is selected from the group consisting of mineral clays and gypsum; wherein said mineral clay is at least one selected from the group consisting of kaolin, attapulgite and bentonite.

8. The fertilizer composition as claimed in claim 3, wherein said swelling agent is at least one selected from the group consisting of polyacrylic acid, polyacrylate, polyacrylamide, Superabsorbent polymers (SAPs), cellulose grafted polyacrylamide, potassium salt of polyacrylamide and starch grafted polyacrylamide.

9. The fertilizer composition as claimed in claim 3, wherein said dispersing agent is at least one selected from the group consisting of sodium salt of naphthalene sulphonate condensate, sodium alkyl naphthalene sulphonate blend, polyurethane, polyacrylate based dispersing agent and calcium lignosulphonate.

10. The fertilizer composition as claimed in claim 3, wherein said binding agent is at least one selected from the group consisting of carboxymethyl cellulose, methyl cellulose, ethyl cellulose, hydroxymethyl cellulose, hydroxyethyl cellulose, hydroxypropylmethyl cellulose, hydroxyethylpropyl cellulose, corn starch, potato starch, starch acetates, ionic starches, polyvinyl alcohol, polyvinyl acetate, polyethylene glycol and polylactic acid.
